(19) United States
(12) Patent Application Publication
(10) Pub. No.: US 2023/0133027 A1
(43) Pub. Date: May 4, 2023

(54) METHOD AND APPARATUS FOR INTENT-GUIDED AUTOMATED SPEECH RECOGNITION

(71) Applicant: Uniphore Technologies, Inc., Palo Alto, CA (US)

(72) Inventor: Aravind GANAPATHIRAJU, Hyderabad (IN)

(21) Appl. No.: 17/978,197

(22) Filed: Oct. 31, 2022

(30) Foreign Application Priority Data
Oct. 30, 2021 (IN) 202111049850

(51) Int. Cl. G10L 15/18; G10L 15/26; H04M 3/51

(52) U.S. Cl. CPC G10L 15/1815; G10L 15/26; H04M 3/5183

(57) ABSTRACT

In a method and apparatus for intent-guided automatic speech recognition (ASR) in customer service center environments, the method includes detecting, at a call analytics server (CAS), from a call audio of a call between at least two persons comprising a first person and a second person, an intent expressed by one of the first person or second person. The method further includes verifying that the detected intent is on a predefined list of intents and focusing the range of applicability of a language prediction (LP) module, where the LP module uses one or more language models (LMs), used by the CAS to generate a transcribed text from the call audio, to a conversational domain corresponding to the detected intent.

### CROSS-REFERENCE TO RELATED APPLICATIONS

This application claims the benefit of the Indian Provisional Patent Application No. 202111049850, filed on Oct. 30, 2021, incorporated by reference herein in its entirety.

### FIELD

The present invention relates generally to speech audio processing, and particularly to an intent-guided automated speech recognition in customer center environments.

### BACKGROUND

Several businesses need to provide support to its customers, which is provided by a customer service center (also known as a “call center”) operated by or on behalf of the businesses. Customers of a business place an audio or a multimedia call to, or initiate a chat with, the call center of the business, where customer service agents address and resolve customer issues, to address the customer's queries, requests, issues and the like. The agent uses a computerized management system used for managing and processing interactions or conversations (e.g., calls, chats and the like) between the agent and the customer. The agent is expected to understand the customer's issues, provide appropriate resolution, and achieve customer satisfaction.

Customer service management systems (or call center management systems) may help with an agent's workload, complement or supplement an agent's functions, manage agent's performance, or manage customer satisfaction, and in general, such call management systems can benefit from understanding the content of a conversation, such as entities mentioned, intent of the customer, among other information. Such systems may rely on automated identification of intent and/or entities of the customer (e.g., in a call or a chat). Conventional systems, which typically rely on an artificial intelligence and/or machine learning (AI/ML) model, for example, to classify the call or a chat into an intent classification, often suffer from low accuracy. The AI/ML models depend on accurate automated speech recognition (ASR), which places immense pressure on making the ASR accurate in all contexts.

Accordingly, there exists a need in the art for a method and apparatus for an improved ASR in customer service environments.

### SUMMARY

The present invention provides a method and an apparatus for an improved entity extraction, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic depicting an apparatus for intent-guided automated speech recognition (ASR) in call center environments, in accordance with one embodiment.

FIG. 2 illustrates a method for intent-guided ASR in call center environments, performed by the apparatus of FIG. 1, in accordance with one embodiment.

### DETAILED DESCRIPTION

Embodiments of the present invention relate to a method and an apparatus for intent-guided automatic speech recognition (ASR) for use in customer service environments, for example, in a conversation or a call between a customer and an agent.

Typically, most modern conversational artificial intelligence (AI) models for contact centers treat Agent and Customer speech (i.e., “channels”) independently, meaning that each channel (Agent and customer) is treated as independent streams of speech. However, human conversations often are constrained to topics based on what the customer says (if the call is customer-initiated) or what the Agent says (if the call is agent-initiated). The content of speech from the Agent and the Customer are often synchronized and limited to a very narrow domain and vocabulary. This topical information from one channel can have a significant impact on the content of the speech on the other channel. Ignoring the constraint that the conversation places on the content of the speech from either party often hurts the performance of the language models (LMs) used for automated speech recognition (ASR), since they have to take into account an immense vocabulary. This places immense pressure on making the ASR accurate in all contexts.

In embodiments disclosed herein, a language prediction (LP) module of a call analytics server (CAS) comprising one or more language models (LMs) is configured to detect, from a transcript of a call between at least two persons comprising a first person and a second person, an intent from a list of predefined intents expressed by one of the first person or second person. Upon the detection of the intent, the range of applicability of the LP module is focused to a conversational domain corresponding to the detected intent, so as to render the LP module to be more efficient and more precise.

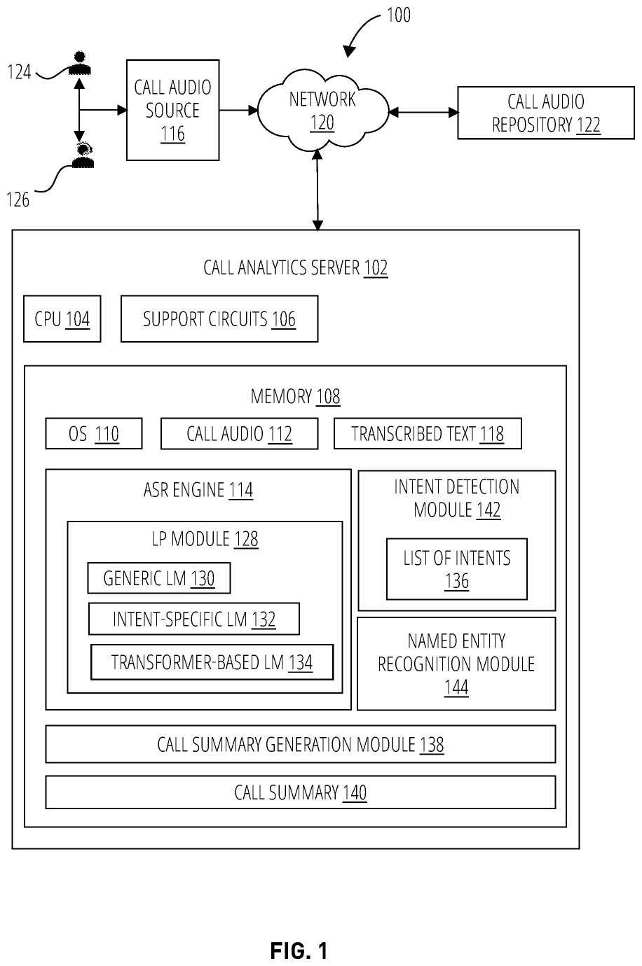

FIG. 1 is a schematic depicting an apparatus 100 for automatically generating a call summary in call center environments, in accordance with an embodiment. The apparatus 100 comprises a call audio source 116, a network 120 and a call analytics server (CAS) 102. The call audio source 116 is, for example, a call center to which a customer 124 of a business calls, and a customer service agent 126 representing the business.

The call audio source 116 provides the call audio 112 of a call to the CAS 102. In some embodiments, the call audio source 116 is a call center providing live or recorded audio of an ongoing call between the agent 126 and the customer 124. In some embodiments, the agent interacts with a graphical user interface (GUI), which may be on a computer, smartphone, tablet or other such computing devices capable of displaying information and receiving inputs from the agent.

The CAS 102 includes a CPU 104 communicatively coupled to support circuits 106 and a memory 108. The CPU 104 may be any commercially available processor, microprocessor, microcontroller, and the like. The support circuits 106 comprise well-known circuits that provide functionality to the CPU 104, such as, a user interface, clock circuits, Network communications, cache, power supplies, I/O circuits, and the like. The memory 108 is any form of digital storage used for storing data and executable software. Such memory includes, but is not limited to, random access memory, read only memory, disk storage, optical storage, and the like. The memory 108 includes computer readable instructions corresponding to an operating system (OS) 110, a call audio 112, for example, audio of a call between a customer and an agent received from the call audio source 116, an ASR Engine 114, a call audio repository 122 and a language prediction module (NP) 128.

The network 120 is a communication Network, such as any of the several communication Networks known in the art, and for example a packet data switching Network such as the Internet, a proprietary Network, a wireless GSM Network, among others. The network 120 is capable of communicating data to and from the call audio source 116, the CAS 102 and/or any other networked devices.

The ASR Engine 114 is configured to transcribe the call audio 112 (spoken words) to corresponding transcribed text 118 (text words or tokens) using automatic speech recognition (ASR) techniques. In some embodiments, the ASR Engine 114 is implemented on the CAS 102 or is co-located with the CAS 102. The ASR Engine 114 comprises or relies on a language prediction (LP) module 128, which uses various statistical and probabilistic techniques to determine the probability of a given sequence of words occurring in a sentence. This helps the ASR Engine 114 at accurately and efficiently determining the sequences of words expressed in the call audio 112. Language models (LMs) analyze bodies of text data to provide a basis for their word predictions. The LM provides context to distinguish between words and phrases that sound phonetically similar. The ASR Engine 114 relies on the LP module 128 to generate the transcribed texts 118.

In some embodiments, the LP module 128 may comprise one or more language models (LMs), such as neural Network models or the like. For example, this may include bi-directional Recursive Neural Networks (RNN) algorithms or the like.

In some embodiments, the LP module 128 is operable to use different LMs and/or to switch/substitute one LM for another better suited LM to a conversational domain of a given conservation. For example, in the following exemplary conversation between a customer and an agent:
1. Agent: Thanks for calling XYX, how may I help you?
2. Customer: Hi, I would like to reset my password.
3. Agent: Sure, I can help with that, can you first confirm the last 4 digits of your SSN?
4. Customer: Yeah, it's 4 3 5 6.
5. Agent: Great, thanks for providing the information. Let me see if I can reset the password right away.
6. Customer: Thanks.
7. Agent: It's done. You will receive an email to your registered email account with a link to reset the password. Once you access the link and follow the simple steps, you will be all set.
8. Customer: That was a breeze. Thanks for the help.

In the example above, at line 2 the customer indicates that he or she wants to reset his/her password. Thus, the context or intent for the conversation is “password reset”, and moving forward, the next set of sentences (3-8) spoken by the two parties will be limited or restrained to that conversational domain. By conversational domain, what is meant is an ensemble of words (e.g., a vocabulary and syntax) that is typically associated with a given conversational subject or context. By restraining or focusing the range of applicability of the LP module 128 to a given conversational domain, it can be made more precise and more efficient.

Thus, LP module 128 may include a generic LM 130 that is configured to be applied to any number of conversational domains and has a wide range of applicability. However, these models typically required a larger amount of training data and are much more CPU intensive. In addition, for a given intent or context, the generic LM 130 may be less precise than another LM that has been configured or trained only on a subset of the training data pertaining to the intent or context.

Thus, LP module 128 may also comprise one or more intent-specific LMs 132. These models may be similar in construction to the generic LM 130 but are optimized for a given intent or context only. This may be done by training the intent-specific LM 132 using training data limited to the intent or context. For example, the number of words required to understand a conversation limited to a conversional domain may be limited, for example, to a few hundred words instead of many thousands.

In addition, in some embodiments, the LP module 128 may comprise transformer-based language models (or just transformers). These may be deep learning models, such as recursive neural Network (RNN) models or the like, that use attention techniques to allow the model to focus on the relevant parts of an input sequence as needed. The transformer-based LM may be configured to use one or more intent as an input so as to selectively bias (via adjusting the weights) the transformer-based LM towards a corresponding one or more language or conversional domains, thereby rendering the transformer-based LM more efficient and more accurate when processing text data in those conversational domains than a generic LM would be.

The transcribed text 118 may be further processed by the intent detection module 142 and named entity recognition module 144.

In some embodiments, the intent detection module 142 detects intents based on pre-configured key phrases, which are searched for in the preprocessed text by looking for an exact match of the configured key phrase(s) (exact search), or by looking for a text similar to the configured key phrases (fuzzy search), for example, using sentence similarity measure, stemming, and the like. In some embodiments, IDM 132 detects intents using techniques as known in the art. The intent detection module 142 may further comprise or have access to a predetermined list of intents 136 that corresponds to either available intent-specific LMs 132 and/or biasing options for the transformer-based LM 134. Thus, the intent detection module 142 may be configured that upon an intent from the list of intents 136 being detected (e.g., the detected intent), the detected intent is sent back to the ASR Engine 114 so that the ASR Engine 114 may use it to focus its range of applicability to the conversational domain associated with that detected intent.

The named entity recognition (NER) module 144 recognizes entities based on one or more of machine learning (ML) based named entity recognition (NER) model, a pattern-based approach, or an intent-based approach (in which a string and a free-form entity are extracted). In some embodiments, the supporting entities include person name, organization, location, date, number, percentage, money, float, alphanumeric, email, duration, time, relationship and affirmation. In some embodiments, the recognizes entities using techniques as known in the art. In some embodiments, when entities are recognized, values associated with the entities are also identified.

In some embodiments, the CAS 102 may further comprise in the memory 108 additional modules and/or engines to extract additional information from the transcribed text 118 generated from the ASR Engine 114. For example, a summary generation module (SGM) 138 may be used to generate a call summary 140 or the like. The SGM 138 further post-processes the results of the previous modules and/or engines to convert entities into a human readable format, for example, ‘25 dollars’ is converted to ‘$25’, ‘25 dollars and 60 cents’ to ‘$25.60’, ‘45 point 60’ to ‘45.60’, ‘50 percent’ to ‘50%’; relative dates are converted to actual dates, for example, ‘today’, ‘yesterday’, ‘next month’ or ‘last year’ and similar are converted to an actual date. The SGM 138 uses the post-processed information to generate the call summary 140 including the entities, intents, and additional information, such as the call transcript, and any other information configured therein. The call summary 140, so generated, may then be sent for display to another device, such as a device used by the agent 126, to be displayed on a graphical user interface GUI or the like.

In some embodiments, the call audio repository 122 includes recorded audios of calls between a customer and an agent, for example, the customer and the agent received from the call audio source 116. In some embodiments, the call audio repository 122 includes training audios, such as previously recorded audios between a customer and an agent, and/or custom-made audios for training machine learning models. This may include training the generic LM 130, the intent-specific LMs 132 and/or the transformer-based LM 134. It may also include training any neural Network model used by the intent detection module 142 and/or named entity recognition module 144.

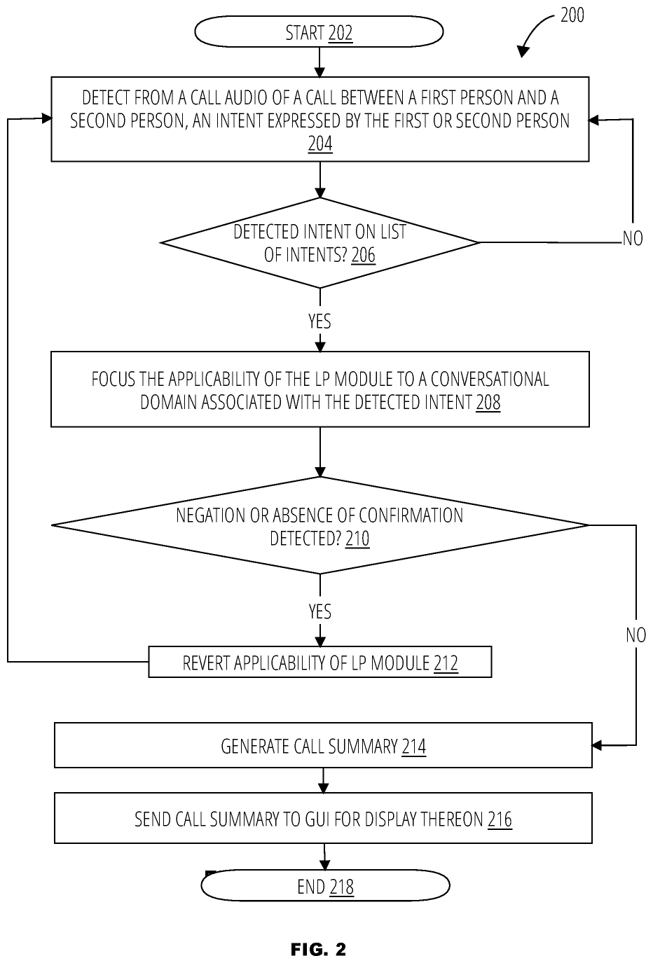

FIG. 2 illustrates a method 200 for intent-guided automated speech processing in call centers environments, performed by the apparatus 100 of FIG. 1, in accordance with one embodiment. In particular, the method 200 is performed by the analytics server (CAS) 102. The method 200 starts at step 202, and proceeds to step 204, at which, the method 200 detects, using the intent detection module 142, from the transcribed text 118 of a call between a first person and a second person, generated via the ASR Engine 114, an intent expressed by one of the first person or second person (i.e., the detected intent). At the start of the process, the LP module 128 of the ASR Engine 114 relies on a generic LM 130 or an unbiased transformer-based LM 134. Going back to the example shown above, this means that the LP module 128 relies on or uses the generic LM 130 for example, to process the conversion until the intent “change my password” is detected at line 2 by the intent detection module 142.

At step 206, the intent detection module 142 checks that the detected intent corresponds to one or more intents in the predefined list of intents 136. If not, then the LP module 128 of the ASR Engine 114 keeps processing the call audio 112 using the generic LM 130. In contrast, if the detected intent corresponds to an intent in the list of intents 136, then the range of applicability of the LP module 128 may be focused on the conversional domain corresponding to that detected intent.

Thus, at step 208, the detected intent is sent back to the LP module 128 as an input thereof, upon which the LP module 128 focuses or restricts its range applicability correspondingly. The skilled person in the art will appreciate that different means of doing this may be used, without limitation. Below are two exemplary means of achieving this.

In a first case, the LP module 128 uses or relies on the generic LM 130 and the one or more intent-specific LMs 132. As mentioned above, each intent-specific LM 132 is pre-trained on a limited training data set comprising words corresponding a conversational domain associated with a given intent or context. In some embodiments, each intent in the list of intents 136 may correspond to a corresponding available intent-specific LM 132. Thus, at step 208, the generic LM 130 used initially may be substituted for the intent-specific LM 132 corresponding to the detected intent. This intent-specific LM 132 is used to process the rest of the transcribed text 118, either immediately or at the next detected turn.

In a second case, instead, at step 208, the LP module 128 relies on or uses the transformer-based LM 134. Initially the transformer-based LM 134 is unbiased, but upon receiving the detected intent, uses it as an input to bias or modify its range of applicability via an adjustment of the weights of the model via a transformer-based method or technique. The adjusted model will be more efficient and more precise at processing call audio 112. In addition, when using the transformer-based LM 134, two or more intents may be used to focus the range of applicability of the LP module 128 simultaneously.

In either case, the detected intent is used as an input at step 208 to focus the range of applicability of the LP module 128. The resulting intent-specific LM 132 (or the adjusted transformer-based LM 134) is used to process the rest call audio 112 as required, either immediately or at the next detected turn.

In some embodiments, at step 210, the intent detection module 142 may further detect a negation or an absence of confirmation of the detected intent from the other person taking part in the call audio 112. By negation, what is meant may include detecting another intent that contradicts the first detected intent. By an absence of confirmation, what is meant may include not detecting the same intent expressed by the other person in the conversation. This may be time-limited, for example by waiting a given maximum amount of time after initially detecting the intent for a confirmation of the same intent by the other person.

In some embodiments, if the confirmation is not detected, and/or if a negation of the intent is detected, then at step 212 the range of applicability of the LP module 128 is reverted, for example by either using again the generic LM 130 (case 1) or by unbiasing the transformer-based LM 134 (case 2). The call audio 112 may be processed again (step 204) until another intent is detected or until the call audio 112 ends.

If there is no negation nor an absence of confirmation, then the rest of the call audio 112 is processed until completion. At step 214, the method 200 generates a call summary via the call summary generation module 138, for example, the call summary 140. The call summary 140 may be sent at step 216 to a user device for display on a graphical user interface (GUI). In some embodiments, at least a portion of the call summary is sent to the user device for display on the GUI in real time, and in some embodiments, at least a portion of the call summary is sent to the user device for display on the GUI while the call is active. In some embodiments, a deliberate delay may be introduced at one or more steps, including performing the method 200 after the call is concluded, and all such variations are contemplated within the method 200.

The method 200 proceeds to step 218, at which the method 200 ends.

While audios have been described with respect to call audios of conversations in a call center environment, the techniques described herein are not limited to such call audios. Those skilled in the art would readily appreciate that such techniques can be applied readily to any audio containing speech, including single party (monologue) or a multi-party speech, or a multimedia call, such as a video call.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

I/We claim:

1. A computing apparatus comprising:
a processor; and
a memory storing instructions that, when executed by the processor, configure the apparatus to:
detect, at a call analytics server (CAS), from a call audio of a call between at least two persons comprising a first person and a second person, an intent expressed by one of the first person or second person;
verify that the detected intent is on a predefined list of intents;
focus the range of applicability of a language prediction (LP) module, the LP module using one or more language models (LMs), used by the CAS to generate a transcribed text from the call audio, to a conversational domain corresponding to the detected intent.

2. The computing apparatus of claim 1, wherein said focusing includes:
substitute a generic LM of the LP module for an intent-specific LM optimized for said conversational domain.

3. The computing apparatus of claim 1, wherein said one or more LMs include a transformer-based LM, the transformer LM operable to be selectively biased towards one or more conversational domains corresponding to the predefined list of intents, and wherein said focusing includes:
using said detected intent as an input for said transformer LM, thereby biasing the transformer LM model towards said conversational domain.

4. The computing apparatus of claim 3, wherein said detect further includes detecting two or more intents from the predefined list of intents, and wherein said focusing further includes:
using the two or more detected intents as an input for the transformer LM, thereby biasing the transformer LM towards two or more conversational domains simultaneously.

5. A non-transitory computer-readable storage medium, the computer-readable storage medium including instructions that when executed by a computer, cause the computer to:
detect, at a call analytics server (CAS), from a call audio of a call between at least two persons comprising a first person and a second person, an intent expressed by one of the first person or second person;
verify that the detected intent is on a predefined list of intents;
focus the range of applicability of a language prediction (LP) module, the LP module using one or more language models (LMs), used by the CAS to generate a transcribed text from the call audio, to a conversational domain corresponding to the detected intent.

6. The computer-readable storage medium of claim 5, wherein said focusing includes:
substitute a generic LM of the LP module for an intent-specific LM optimized for said conversational domain.

7. The computer-readable storage medium of claim 5, wherein said one or more LMs include a transformer-based LM, the transformer LM operable to be selectively biased towards one or more conversational domains corresponding to the predefined list of intents, and wherein said focusing includes:
using said detected intent as an input for said transformer LM, thereby biasing the transformer LM model towards said conversational domain.

8. The computer-readable storage medium of claim 7, wherein said detect further includes detecting two or more intents from the predefined list of intents, and wherein said focusing further includes:
using the two or more detected intents as an input for the transformer LM, thereby biasing the transformer LM towards two or more conversational domains simultaneously.

9. A method for automatically generating a call summary, the method comprising:
detecting, at a call analytics server (CAS), from a call audio of a call between at least two persons comprising a first person and a second person, an intent expressed by one of the first person or second person;
verifying that the detected intent is on a predefined list of intents;
focusing the range of applicability of a language prediction (LP) module, the LP module using one or more language models (LMs), used by the CAS to generate a transcribed text from the call audio to a conversational domain corresponding to the detected intent.

10. The method of claim 9, wherein said focusing includes:
substituting a generic LM of the LP module for an intent-specific LM optimized for said conversational domain.

11. The method of claim 9, wherein said one or more LMs include a transformer-based LM, the transformer LM operable to be selectively biased towards one or more conversational domains corresponding to the predefined list of intents, and wherein said focusing includes:
using said detected intent as an input for said transformer LM, thereby biasing the transformer LM model towards said conversational domain.

12. The method of claim 11, wherein said detecting further includes detecting two or more intents from the predefined list of intents, and wherein said focusing further includes:
using the two or more detected intents as an input for the transformer LM, thereby biasing the transformer LM towards two or more conversational domains simultaneously.
